(19) United States
(12) Patent Application Publication
(10) Pub. No.: US 2018/0149949 A1
(43) Pub. Date: May 31, 2018

(54) DOME-TYPE THREE-AXIS GIMBAL

(71) Applicant: Hanwha Techwin Co., Ltd., Changwon-si (KR)

(72) Inventors: Seung Jin KIM, Changwon-si (KR); Sang Ryeol LEE, Changwon-si (KR)

(73) Assignee: Hanwha Techwin Co., Ltd., Changwon-si (KR)

(21) Appl. No.: 15/466,987

(22) Filed: Mar. 23, 2017

(30) Foreign Application Priority Data
Nov. 29, 2016 (KR) 10-2016-0160354

(51) Int. Cl. G03B 17/56; F16M 13/02; F16M 11/06; F16M 11/18; H04N 5/232

(52) U.S. Cl. CPC G03B 17/561; F16M 13/022; G03B 15/006; F16M 11/18; H04N 5/2328; F16M 11/06

(57) ABSTRACT

A three-axis gimbal includes: a first housing including a first rotary shaft, the first rotary shaft configured to rotate the first housing in a first direction; a first bracket attached to, and extending from the first housing; a second bracket including second rotary shafts, the second rotary shafts rotatably supported by the first bracket, the second bracket configured to be rotatable in a second direction; a camera module including a third rotary shaft, the third rotary shaft rotatably supported on the second bracket, the camera module configured to be rotatable in a third direction; and a second housing accommodating the second rotary shafts and the third rotary shaft.

### CROSS-REFERENCE TO RELATED PATENT APPLICATION

This application claims priority from Korean Patent Application No. 10-2016-0160354, filed on Nov. 29, 2016 the disclosure of which is incorporated herein by reference in its entirety.

### BACKGROUND

### 1. Field

Apparatuses consistent with exemplary embodiments relate to a gimbal structure of a camera for an unmanned aerial vehicle (UAV), and more particularly, to a dome-type three-axis rotatable gimbal.

### 2. Description of the Related Art

As unmanned aerial vehicles (UAVs) increasingly become popular, and the interest in cameras that are coupled to, and used along with, the UAVs has increased. Cameras used in the UAVs need to be light in weight and compact in size so that the UAVs can capture images while flying in an extended time in any given conditions, and so that unnecessary air resistance can be prevented.

In the related art, a camera used in a UAV has a gimbal structure which maintains level so as to be able to stably capture images even upon the occurrence of displacement and vibration during a flight. The gimbal structure includes a seat portion on which the camera can be placed and a motor which rotates the seat portion about each rotation axis. With this arrangement of the seat portion and the motor, the gimbal structure thus allows an image pickup unit of the camera to stably capture and form an image.

The configuration of the gimbal structure may vary depending on the structure of the UAV. For a fixed wing drone, a dome-type gimbal 100 illustrated in FIG. 1 may be used for remote monitoring and surveillance purposes. However, the gimbal of FIG. 1 is a two-axis gimbal capable of controlling yaw rotation and pitch rotation, and thus cannot control roll rotation. Although the gimbal 100 of FIG. 1 has a dome-type housing and can thus be safeguarded from disturbance, the gimbal of FIG. 1 cannot be used in a flight vehicle such as a rotor blade drone or a multicopter capable of making a sharp turn.

For a rotor blade drone, a three-axis gimbal 200 illustrated in FIG. 2 may be used in order to cope with six-degrees-of-freedom vibration. However, as is apparent from FIG. 2, the three-axis gimbal 200 has no designated housing for protecting an internal gimbal structure and a camera from an external environment and may thus be highly vulnerable to external disturbances.

To address this problem associated with the three-axis gimbal 200 of FIG. 2, a three-axis gimbal 300 illustrated in FIG. 3 has been suggested in which separate housings are provided for separate rotary shafts for protecting a gimbal and a camera from disturbances. Because the three-axis gimbal 300 of FIG. 3 has a housing for each of the rotary shafts and has a waterproof/dustproof structure for each of the rotary shafts, friction may occur between the rotary shafts and the respective housing during the rotation of each of the rotary shafts, and therefore, a motor capable of providing a large force for rotating the rotary shafts is needed. Consequently, to provide increased force to rotate the rotary shafts servo motors are generally used for the rotary shafts. However, because the servo motors need to be feedback-controlled using measurements provided by an encoder and are connected to gears to drive the rotary shafts, a backlash phenomenon may occur in connection with the gear heads, and this is not advantageous in reducing the weight and volume of the entire three-axis gimbal.

In a case in which a three-axis gimbal is formed by covering the three-axis gimbal 200 of FIG. 2 with a dome-type housing of FIG. 1 to solve the shortcomings of the three-axis gimbal 200 of FIG. 2, the size of an entire housing for the three-axis gimbal considerably increases because of the order of arrangement of yaw, roll, and pitch rotary shafts.

### SUMMARY

Exemplary embodiments of the present disclosure provide a dome-type three-axis rotatable gimbal.

However, exemplary embodiments of the present disclosure are not restricted to those set forth herein. The above and other exemplary embodiments of the present disclosure will become more apparent to one of ordinary skill in the art to which the present disclosure pertains by referencing the detailed description of the present disclosure given below.

According to an aspect of an exemplary embodiment, there is provided a three-axis gimbal, including: a first housing accommodating a yaw rotary shaft, which provides yaw rotation; a first bracket fixed to, and extending from, an exterior side of the first housing; a second bracket mounted to pitch rotary shafts, which are rotatably supported by the first bracket, to be rotatable in a pitch direction; a camera module mounted to a roll rotary shaft, which is rotatably supported on an inside of the second bracket, to be rotatable in a roll direction; and a second housing accommodating the pitch rotary shafts and the roll rotary shaft.

The three-axis gimbal may further include a dome cover accommodating the first housing and the first bracket.

The first bracket may include a first bridge, which is fixed to the exterior side of the first housing, and two first extensions, which extend from both ends of the first bridge to rotatably support the pitch rotary shafts.

The second bracket may include two second extensions, which are rotatably supported by the pitch rotary shafts, and a second bridge, which connects the two second extensions and supports the roll rotary shaft.

The second bracket may include two second extensions, which are rotatably supported by the pitch rotary shafts, a second bridge, which connects first ends of the two second extensions and supports the roll rotary shaft, and a third bridge, which connects second ends of the two second extensions and rotatably supports a first end of the camera module so as for the camera module to be rotatable about a direction of the roll rotary shaft.

A portion of the third bridge that supports the camera module may be opened to be able to transmit light therethrough.

The three-axis gimbal may further include a laser range finder (LRF) coupled to a side of the camera module.

The LRF may be coupled to a side of the camera module that is parallel to the pitch rotary shafts.

The LRF may be coupled to a side of the camera module that is orthogonal to the pitch rotary shafts.

The first housing may further accommodate a controller configured to control the three-axis gimbal.

The second housing may be formed as a radial torus centering around the pitch rotary shafts.

A rotation angle of the roll rotary shaft may be in a range of −30° to +30°.

The three-axis gimbal may further include motors rotating the yaw rotary shaft, the pitch rotary shafts, and the roll rotary shaft.

The motors may be direct current (DC) motors.

The camera module may include an image pickup unit, which captures an image of surroundings of the camera module, and the image pickup unit is disposed along the roll rotary shaft.

The camera module may include an image pickup unit, which captures an image of surroundings of the camera module, and the image pickup unit is disposed to face a direction that is orthogonal to the roll rotary shaft and the pitch rotary shafts.

The second housing may include a light-transmissive window, which is disposed at a location corresponding to the camera module and transmits light therethrough.

The light-transmissive window may include an optical filter.

The first bracket may include two first extensions, which are fixed to the exterior side of the first housing and extend from the exterior side of the first housing to rotatably support the pitch rotary shafts.

The three-axis gimbal may further include at least one of an infrared (IR) camera and a thermal camera coupled to a side of the camera module.

According to an aspect of another exemplary embodiment, there is provided a three-axis gimbal, including: a first housing including a first rotary shaft, the first rotary shaft configured to rotate the first housing in a first direction; a first bracket attached to, and extending from the first housing; a second bracket including second rotary shafts, the second rotary shafts rotatably supported by the first bracket, the second bracket configured to be rotatable in a second direction; a camera module including a third rotary shaft, the third rotary shaft rotatably supported on the second bracket, the camera module configured to be rotatable in a third direction; and a second housing accommodating the second rotary shafts and the third rotary shaft.

The second rotary shafts may extend in a direction substantially orthogonal to the first rotary shaft and the third rotary shaft, and the first rotary shaft may extend in a direction substantially orthogonal to the third rotary shaft.

The first housing and the first bracket may be configured to rotate about the first rotary shaft, the second bracket is configured to rotate about the first rotary shaft and the second rotary shafts and the camera module may be configured to rotate about the first rotary shaft, the second rotary shafts and the third rotary shaft.

The second bracket may be configured to rotate with respect to the first bracket and the camera module is configured to rotate with respect to the second bracket.

The first bracket may include: a first bridge attached to the first housing; and a plurality of first extensions extending from opposite ends of the first bridge to rotatably support the second rotary shafts.

The second bracket may include: a second bridge supporting the third rotary shaft; and a plurality second extensions extending from opposite ends of the second bridge, each of the second rotary shafts protruding from a respective second extension.

The second bracket may include: two second extensions including a left second extension and a right second extension, the left and right second extensions rotatably supported by the second rotary shafts; a second bridge connecting first ends of the two second extensions and supports the third rotary shaft; and a third bridge connecting second ends of the two second extensions and rotatably supports a first end of the camera module so as for the camera module to be rotatable about a direction of the third rotary shaft.

A portion of the third bridge that supports the camera module may be configured to transmit light therethrough.

The first housing may be configured to accommodate a controller configured to control the three-axis gimbal.

The second housing may be formed as a radial torus and is configured to rotate about the pitch rotary shafts.

A rotation angle of the third rotary shaft may be in a range of −30° to +30°.

The three-axis gimbal may further include: a first motor configured to drive the first rotary shaft; a second motor configured to drive one of the second rotary shafts; and a third motor configured to drive the third rotary shaft.

The camera module may include an image capturer configured to capture an image of surroundings of the camera module, and the image capturer may be disposed along the third rotary shaft.

The camera module may include an image capturer configured to capture an image of surroundings of the camera module, and the image capturer may be disposed to face a direction that is orthogonal to the third rotary shaft and the second rotary shafts.

The first bracket may include two first extensions attached to the first housing and extending from the first housing to rotatably support the second rotary shafts.

According to an aspect of an exemplary embodiment, there is provided a three-axis gimbal, including: a first housing including: a first rotary shaft, the first rotary shaft configured to drive the first housing in a first rotational direction; and a first bracket attached to, and extending from the first housing; and a second housing including a second bracket rotatably attached to the first bracket via a left second rotary shaft and a right second rotary shaft, the second bracket configured to rotate with respect to the first bracket; and a camera module including a third rotary shaft, the third rotary shaft rotatably supported on the second bracket, the camera module configured to be rotatable with respect to the second bracket. The camera module may be configured to rotate with respect to the first bracket and the first housing.

The left and right second rotary shafts may extend in a direction substantially orthogonal to the first rotary shaft and the third rotary shaft, and the first rotary shaft may extend in a direction substantially orthogonal to the third rotary shaft.

The first bracket may include: a first bridge attached to the first housing; and a left first extension and a right first extension extending from opposite ends of the first bridge. The left first extension may support the left second rotary shaft and the right first extension may support the right second rotary shaft.

The second housing may be provided between the left first extension and the right first extension.

According to the aforementioned and other exemplary embodiments of the present disclosure, a dome-type housing is employed in a three-axis rotatable gimbal. Thus, the three-axis rotatable gimbal can be stably driven even in the presence of disturbance, and a desired gimbal movement can be obtained with a small driving force.

Other features and exemplary embodiments may be apparent from the following detailed description, the drawings, and the claims.

### BRIEF DESCRIPTION OF THE DRAWINGS

The above and/or other exemplary embodiments and features of the present disclosure will become more apparent by describing in detail exemplary embodiments thereof with reference to the attached drawings, in which:

FIG. 1 is a schematic view illustrating a two-axis gimbal structure of the related art;

FIG. 2 is a schematic view illustrating f a three-axis gimbal structure of the related art;

FIG. 3 is a schematic view illustrating another three-axis gimbal structure of the related art;

FIG. 4 is a perspective view illustrating an exterior structure of a three-axis gimbal according to an exemplary embodiment;

FIG. 5 is a perspective view illustrating an interior structure of the three-axis gimbal according to the exemplary embodiment of FIG. 4;

FIG. 6 is a perspective view illustrating a second housing of the three-axis gimbal according to the exemplary embodiment of FIG. 4;

FIG. 7 is a perspective view illustrating a second bracket and a camera module of the three-axis gimbal according to the exemplary embodiment of FIG. 4;

FIG. 8 is another perspective view illustrating the second bracket and the camera module of the three-axis gimbal according to the exemplary embodiment of FIG. 4;

FIG. 9 is a perspective view illustrating a second bracket and a camera module of a three-axis gimbal according to an exemplary embodiment; and

FIG. 10 is a perspective view illustrating an interior structure of a three-axis gimbal according to an exemplary embodiment.

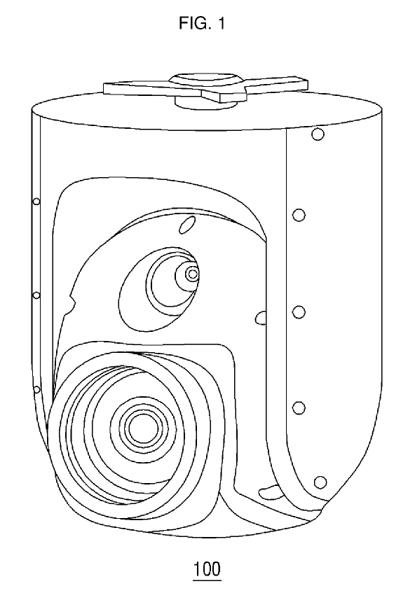

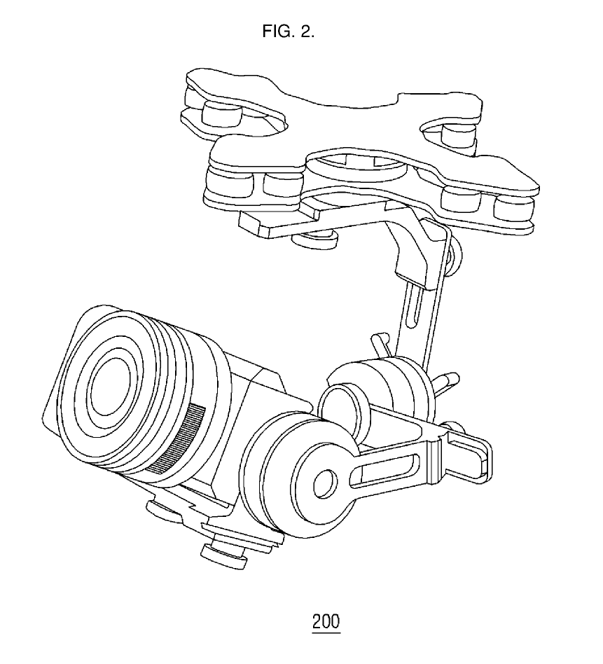

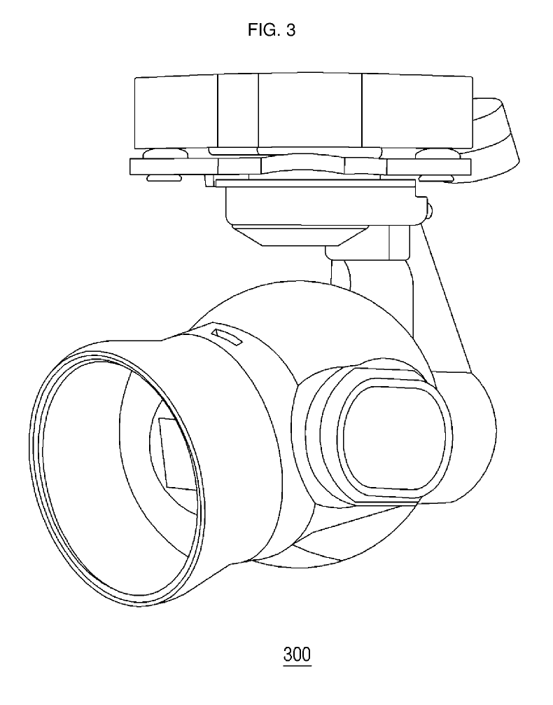

### DETAILED DESCRIPTION

The present inventive concept will now be described more fully hereinafter with reference to the accompanying drawings, in which exemplary embodiments are shown. This inventive concept may, however, be embodied in different forms and should not be construed as limited to the exemplary embodiments set forth herein. Rather, these exemplary embodiments are provided so that this disclosure will be thorough and complete, and will filly convey the scope of the inventive concept to those skilled in the art. The same reference numbers indicate the same components throughout the specification. In the attached figures, the thickness of layers and regions is exaggerated for clarity.

Unless defined otherwise, all technical and scientific terms used herein have the same meaning as commonly understood by one of ordinary skill in the art to which this disclosure belongs. It is noted that the use of any and all examples, or exemplary terms provided herein is intended merely to better illuminate the inventive concept and is not a limitation on the scope of the inventive concept unless otherwise specified. Further, unless defined otherwise, all terms defined in generally used dictionaries may not be overly interpreted.

The use of the terms “a” and “an” and “the” and similar referents in the context of describing the exemplary embodiment (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted.

Further, the exemplary embodiments described herein will be described with reference to cross-sectional views and/or schematic drawings that are ideal exemplary figures of the present invention. Thus, the shape of the exemplary figures can be modified by manufacturing techniques and/or tolerances. Further, in the drawings of the present disclosure, each component may be somewhat enlarged or reduced in view of convenience of explanation. Reference numerals refer to same elements throughout the specification and “and/or” include each and every combination of one or more of the mentioned items.

Spatially relative terms should be understood to be terms that include different orientations of components during use or operation in addition to those shown in the drawings. The components can also be oriented in different directions, so that spatially relative terms can be interpreted according to orientation

Exemplary embodiments of the present disclosure will hereinafter be described with reference to the accompanying drawings.

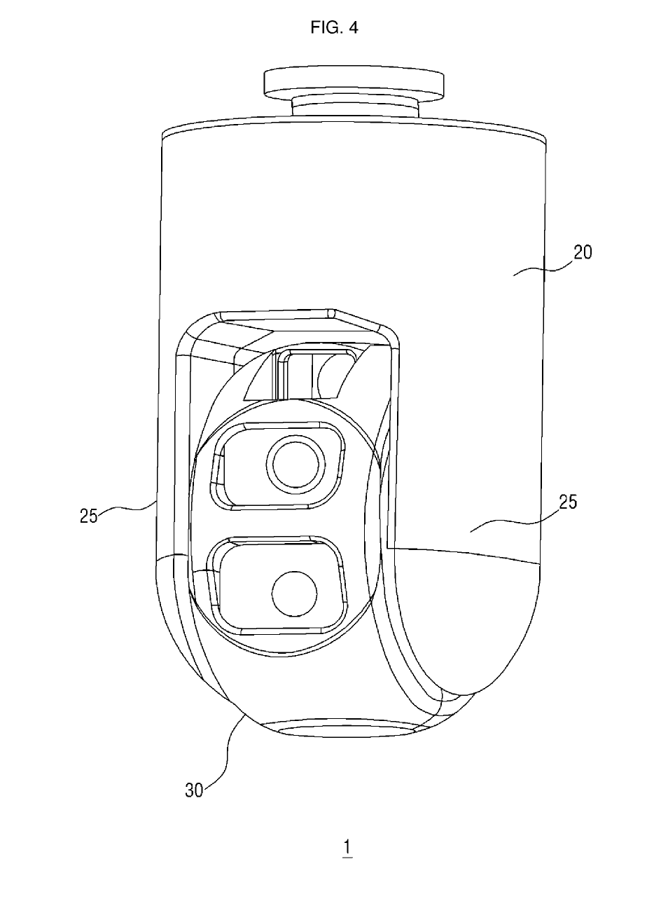

FIG. 4 is a perspective view illustrating an exterior structure of a three-axis gimbal 1 according to an exemplary embodiment.

More specifically, FIG. 4 illustrates the exterior structure of the three-axis gimbal 1 where the exterior structure of the three-axis gimbal 1 includes a dome cover 20 and a second housing 30.

The dome cover 20 is the outermost element of the three-axis gimbal 1. The dome cover 20 protects the internal elements of the three-axis gimbal 1 from external factors/elements such as wind, moisture, and physical impact.

The dome cover 20 is not formed to cover all the elements of the three-axis gimbal 1. For example, as illustrated in FIG. 4, the second housing 30 is not completely covered by the dome cover 20, and instead, side surfaces of the second housing 30 are partially placed the dome cover 20 and makes contact with the dome cover 20. The other remaining elements of the three-axis gimbal 1 are surrounded by, and provided in, the dome cover 20 and may thus be prevented from being damaged by, for example, above-described external factors/elements.

The dome cover 20 is in the form of a cylinder surrounding a base portion of the three-axis gimbal 1, and two sidewalls are branched off, and extend, from the dome cover 20 to provide a space for the second housing 30 as shown in FIG. 4. Specifically, a space is formed between the two side walls 25 so that the second housing 30 can be positioned therein. Once the second housing 30 is installed in the space, the second housing 30 is covered by the two side walls 25 and the second housing 30 is supported by the two side walls 25.

As described above, the second housing 30 is a housing located between the two side walls 25 and is supported by the two side walls 25 and is rotatable about a rotation axis connecting the two side walls 25. Therefore, the second housing 30 may preferably be formed to have a torus shape that is radially symmetrical with respect to at least the rotation axis.

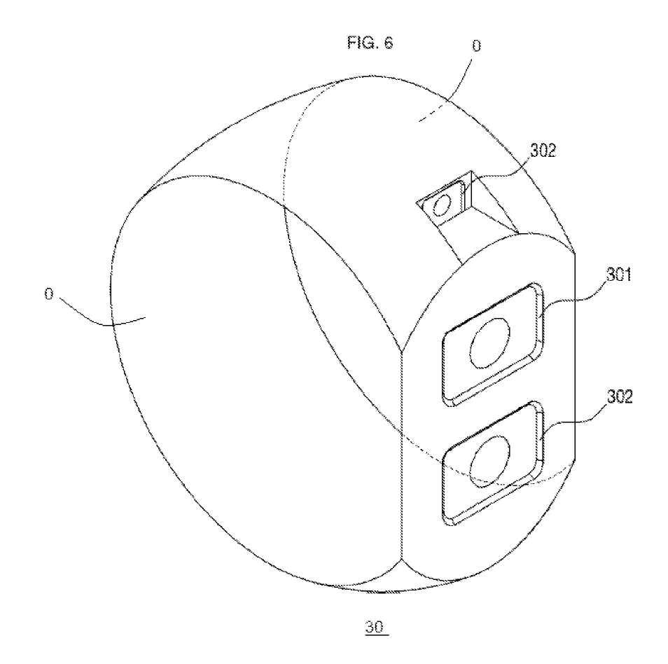

The second housing 30 will be described later with reference to FIG. 6.

The dome cover 20 and the second housing 30 may be coupled together to form the three-axis gimbal 1 and may protect the internal electronic parts of the three-axis gimbal 1 from external factors/elements.

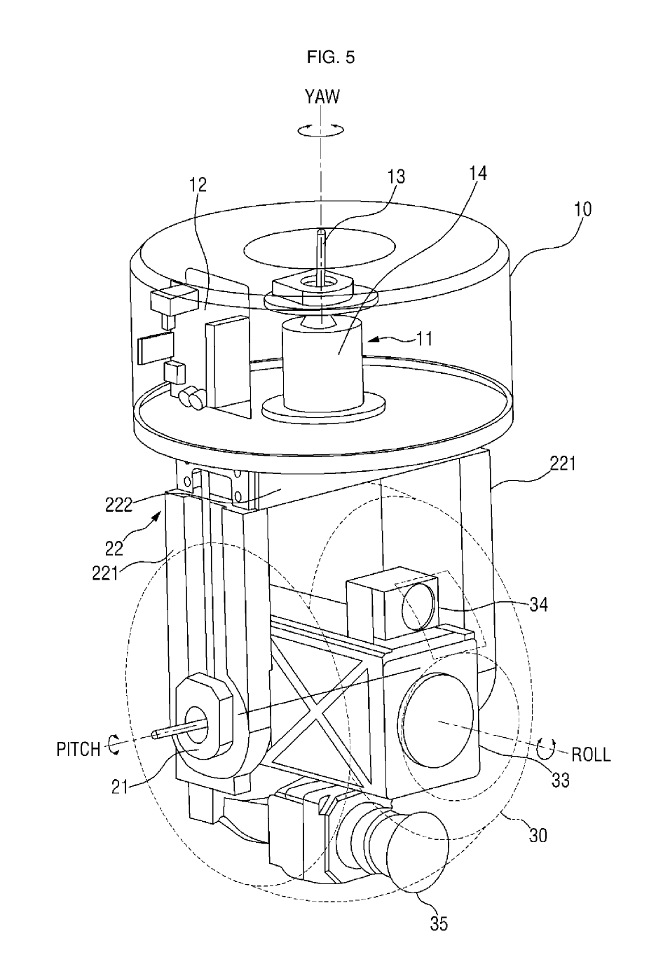

The interior structure of the three-axis gimbal 1 will hereinafter be described with reference to FIG. 5.

FIG. 5 is a perspective view illustrating an interior structure of the three-axis gimbal 1 according to the exemplary embodiment shown in FIG. 4.

Referring to FIG. 5, the three-axis gimbal 1 includes a first housing 10, a first bracket 22, and the second housing 30. FIG. 5 illustrates the entire three-axis gimbal 1 except for the dome cover 20 of FIG. 4.

The first housing 10 is provided inside the dome cover 20 and accommodates a yaw rotary shaft 13, which provides yaw rotation of the three-axis gimbal 1. As illustrated in FIG. 5, the first housing 10 may have a cylindrical shape and may include the yaw rotation shaft 13, which is located at the center of a circular cross section of the first housing 10, and a yaw-direction driving device 11, which provides yaw rotation. However, the shape of the first housing 10 is not particularly limited so long as the first housing 10 is capable of accommodate the yaw rotation shaft 13 and the yaw-direction driving device 11.

The yaw rotary shaft 13 is an element rotating the three-axis gimbal 1 in the yaw direction as indicated in FIG. 5. A yaw rotational direction refers to a direction of rotation with respect to an axis extending in a direction parallel with a protruding/standing direction of the three-axis gimbal 1 from an unmanned aerial vehicle (UAV). For example, referring to FIG. 5, the three-axis gimbal 1 protrudes downward (in a gravitation direction) and the yaw rotational direction corresponds to a rotational direction with respect to the gravitational direction. The yaw rotary shaft 13 extends in a direction parallel with the gravitational direction (i.e., being orthogonal to a plane where the UAV and the three-axis gimbal 1 interface when the three-axis gimbal 1 is connected to the UAV. Accordingly, the yaw rotary shaft 13 may rotate in the yaw direction.

The yaw rotary shaft 13 may be connected to the yaw-direction driving device 11, which has one end formed at the center of the first housing 10. Although not specifically illustrated in FIG. 5, the other end of the yaw rotary shaft 13 may be connected to the UAV so as to be rotatable in the yaw direction. In response to the yaw-direction driving device 11 being driven, the yaw rotary shaft 13 may rotate, and as a result, the entire three-axis gimbal 1 may rotate relative to the UAV in the yaw direction.

Alternatively, the yaw rotary shaft 13 may be fixedly connected to the UAV, and the yaw-direction driving device 11 may connected to the yaw rotary shaft 13 and may rotate about the yaw rotary axis to rotate the entire three-axis gimbal 1 relative to the UAV.

A yaw motor 14 is an element included in the yaw-direction driving device 11. Because the yaw-direction driving device 11 is provided in the first housing 10, the yaw motor 14 is also provided in the first housing 10. A direct current (DC) motor may preferably be used as the yaw motor 14, in which case, the three-axis gimbal 1 can be moved in the yaw direction by a desired amount with a small power without a requirement of an additional element such as an encoder. However, the type of motor that may be used as the yaw motor 14 is not particularly limited thereto.

The yaw-directional driving device 11 is an element moving and rotating the three-axis gimbal 1 in the yaw direction and may include not only the yaw motor 14, but also elements such as bearings, to stably rotate the three-axis gimbal 1 in the yaw direction.

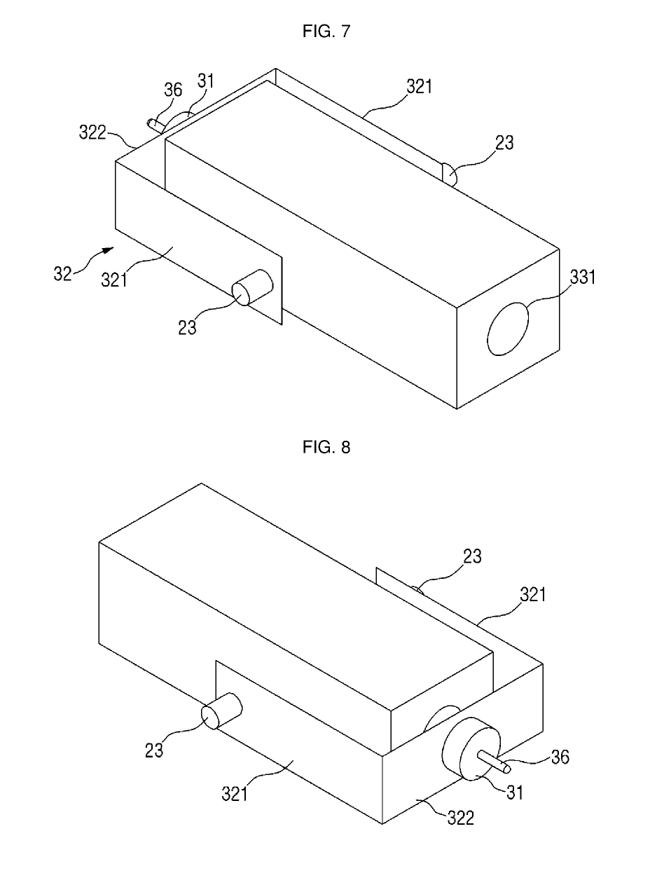

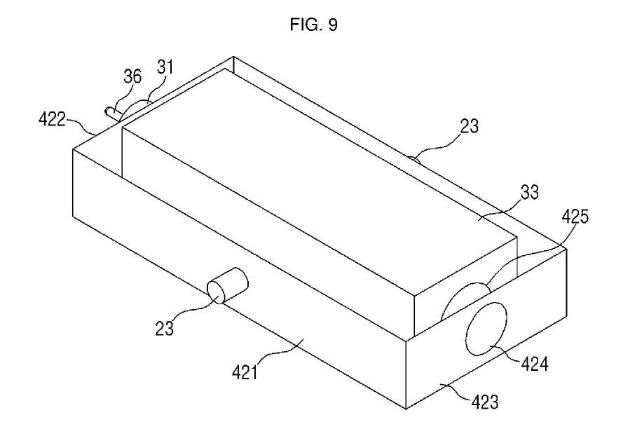

A control unit (or a controller) 12 may be provided in the first housing 10. In order to prevent a large load from being applied to pitch rotary shafts 23 and a roll rotary shaft 36 (shown in FIGS. 7 and 8), which will be described later, and to prevent the volume of the three-axis gimbal 1 from considerably increasing due to the addition of unnecessary elements, the control unit 12, which controls the entire three-axis gimbal 1, may preferably be received in the first housing 10.

The control unit 12 controls, for example, motors included in the three-axis gimbals 1 and driving devices including the motors, respectively, and is electrically connected to the driving devices to transmit control signals to rotate the rotary shafts by a predetermined angle. The control unit 12 is connected to the UAV in a wired or wireless manner, or is directly/indirectly connected to a ground control unit (GCU) for controlling the UAV along with the three-axis gimbal 1. Thus, the control unit 12 receives signals for controlling the three-axis gimbal 1 and generates and transmits control signals to the driving devices of the rotary shafts. Accordingly, a semiconductor device/module capable of performing a logical operation, such as a central processing unit (CPU), a micro-controller unit (MCU), a microprocessor, or a field programmable gate array (FPGA), may be used as the control unit 12. Also, the control unit 12 may include a communication module, such as a Wireless Fidelity (WiFi) module, a ZigBee module, an Ethernet card, or a serial port, to communicate over a wired or wireless network.

The control unit 12 may be electrically connected to each of the driving devices and may transmit control signals, or supply power, to each of the driving devices. Thus, wiring for electrical connection between the control unit 12 and the driving devices may be formed in the first housing 10, the first bracket 22, and a second bracket 32 (shown in FIGS. 7 and 8).

The first bracket 22 is an element connecting the first housing 10 and the second housing 30 and may include a first bridge 222, and first extensions 221, which extend from opposite ends of the first bridge 222 along a direction of the yaw rotary axis (i.e., an extending direction of the yaw rotary shaft 13).

The first bridge 222 of the first bracket 22 is an element that is coupled to the first housing 10. In a case in which two or more first extensions 221 are provided, the first bridge 222 connects the first extensions 221. The first bridge 222 may extend in a direction parallel to a plane extending in a direction orthogonal to the yaw rotary shaft 13. The first bridge 222 is coupled, through the yaw rotary shaft 13, to a side of the first housing 10 opposite to the side of the first housing 10 connected to the UAV, and allows the first extensions 221 to extend in an opposite direction to a direction in which the UAV is located.

The first extensions 221 are elements providing locations for the pitch rotary shafts 23 (also shown in FIGS. 7 and 8) to be coupled to such that the second housing 30 may rotate in the pitch direction while being connected to the first housing 10. The first extensions 221 may extend from opposite ends of the first bridge 222 in a direction parallel to the yaw rotary shaft 13. Two or more first extensions 221 may be provided, but the number of first extensions 221 extending from the first bridge is not particularly limited. In the present exemplary embodiment, a total of two first extensions 221 are provided, one at each end of the first bridge 222.

First ends of the first extensions 221 are connected to the first bridge 222, and the pitch rotary shafts 23 are rotatably supported in regions near second ends opposite to the first ends of the first extensions 221. The pitch rotary shafts 23 will be described later.

In the exemplary embodiment, the first bracket 22 includes the first bridge 222 and two first extensions 221, and the two first extensions 221, which extend from opposite ends of the first bridge 222 along an extending direction of the first extensions 221, rotatably support the pitch rotary shafts 23. However, the exemplary embodiment is not limited thereto. For example, the first bracket 22 may be configured to include only the first extensions 221, and the first extensions 221 may be configured to be directly connected to the first housing 10 and to support the pitch rotary shafts 23. In addition, the shape of the first bracket 22 is not particularly limited to a U shape illustrated in FIG. 5.

As mentioned above, the first extensions 221 rotatably support the pitch rotary shafts 23 in the regions near the second ends opposite to the first ends of the first extensions 221 that are not connected to the first bridge 222. Pitch-direction driving devices 21 are coupled to the first extensions 221 so as for the pitch rotary shafts 23 to be rotatable in the pitch direction.

The pitch rotary shafts 23 are connected to the second bracket 32, the second bracket 32 rotatably supports the roll rotary shaft 36, and the roll rotary shaft 36 supports a camera module 33. The structure in which the pitch rotary shafts 23, the second bracket 32, and the roll rotary shaft 36 are connected are hidden from view in FIG. 5 by the first bracket 22 and the camera module 33 and is thus difficult to be properly identified. Thus, the structure in which the pitch rotary shafts 23, the second bracket 32, and the roll rotary shaft 36 are connected will be described later with reference to FIGS. 7 and 8.

The camera module 33 is a module including a camera and elements for assisting the camera to capture an image of a surrounding subject, and may be box-shaped. However, the shape of the camera module is not particularly limited. The camera module 33 may include an image pickup unit 331, which includes basic camera elements such as an image sensor and a lens for capturing an image of a subject.

More specifically, the image pickup unit 331 includes a lens system, which receives and condenses light, and an image sensor, which obtains a valid signal from the light condensed by the lens system. A charge-coupled device (CCD) or a complementary metal-oxide-semiconductor (CMOS) may be used as the image sensor, but the present disclosure is not limited thereto. The camera unit 33 may further include a video encoder such as a video graphics array (VGA) encoder to convert an optical signal recognized by the image sensor to a storable form. An electrical signal of the image sensor is processed into reproducible data by a video encoder.

The camera of the camera module 33 may be a typical electro-optical (EO) camera, but the type of the camera of the camera module 33 is not particularly limited.

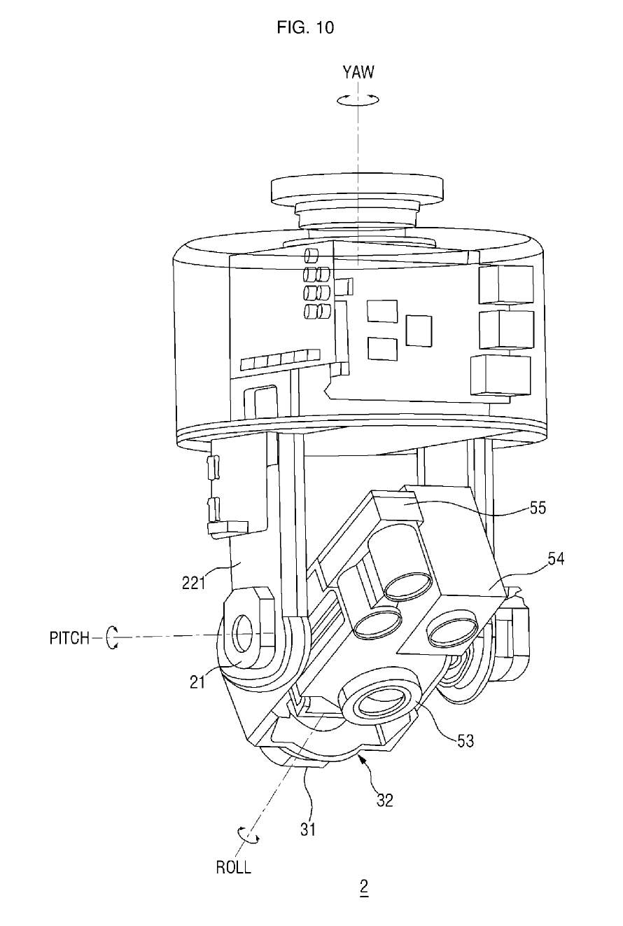

The image pickup unit 331 of the camera module 33 may be disposed to face a direction parallel to an extending direction of the roll rotary shaft 36 as shown in FIGS. 7 and 8. Thus, the image pickup unit 331 may be able to capture an image of a subject located in the direction parallel to the roll rotary shaft 36. However, the arrangement direction of the camera module 33 is not particularly limited, and will be described later in detail with reference to FIG. 10.

The camera module 33 may use a camera other than the typical EO camera to perform an auxiliary role, or may have a plurality of cameras attached thereto. In the present exemplary embodiment, an infrared (IR) camera 35, which captures an image by receiving infrared rays, is additionally provided at a lower side of the camera module 33, and a laser range finder (LRF) 34, which measures distance using laser light, is attached at an upper side of the camera module 33. However, the arrangement directions and the locations of cameras or devices that may be attached to the camera module 33 are not particularly limited. That is, the camera module 33 and various devices that may be coupled to the camera module 33 may be arranged along a direction of the pitch rotary shafts 23 to form one integral body. The arrangement of the camera module 33 and the various devices that may be coupled to the camera module 33 may vary depending on the purpose of use of the three-axis gimbal 1.

Because the IR camera 35 is provided along with the typical EO camera, the three-axis gimbal 1 may be allowed to continue to perform the tasks even in a low-illuminance environment, for example, during the night. In addition, because the LRF 34 is also provided along with the typical EO camera, location information of a subject may be precisely measured, and a technique of automatically tracking a designated subject may be implemented using the three-axis gimbal 1. Moreover, a thermal imaging camera may also be used along with the camera module 33.

The IR camera 35 and the LRF 34 are coupled to sides of the camera module 33, and the IR camera 35, the LRF 34, and the camera module 33 are all rotated in the roll direction by rotation of the roll rotary shaft 36. However, the exemplary embodiment is not particularly limited. For example, the camera module 33 and the other cameras may be coupled to a particular frame, and the frame may be connected and fixed to the roll rotary shaft 36. As another example, only the camera module 33 may be connected to the roll rotary shaft 36, the other cameras may be fixed to a second bridge 322, in which case, only the camera module 33 may rotate in the roll direction.

Referring back to FIG. 5, the second housing 30 is configured to accommodate the camera module 33 and the second bracket 32. The structure and operation of the second housing 30 will hereinafter be described with reference to FIG. 6.

FIG. 6 illustrates the second housing 30 of the three-axis gimbal 1 according to the exemplary embodiment.

Referring to FIG. 6, the second housing 30 accommodates therein the camera module 33, the second bracket 32, and the roll rotary shaft 36 and the pitch rotary shafts 23, which are connected to the second bracket 32.

Specifically, the second housing 30 accommodates the pitch rotary shafts 23 at its outermost portion, and a part of the second bracket 32 is fixed on the inside of the second housing 32. Thus, because the entire second housing 30 rotates in the pitch direction in accordance with the rotation of the second bracket 32 in the pitch direction, the second housing 30 may preferably be formed as a radial torus centering around the pitch rotary shafts 23. The second housing 30 has open faces O facing in the direction of the pitch rotary shafts 23, and the open faces O of the second housing 30 are respectively covered by the second bracket 32 and the dome cover 20 (e.g., the two side walls 25 of the dome cover 20) and are thus shielded from exterior factors/elements.

Because the second housing 30 accommodates the camera module 33, transparent areas need to be formed so that the camera module 33 can transceive (transmit and receive) light to and from outside the second housing 30 and can thus properly capture an image of a surrounding subject. Thus, a light-transmissive window 301, which is transparent enough to transceive the light therethrough, may be formed in the second housing 30, particularly, in a region corresponding to the camera module 33. Also, auxiliary light-transmissive windows 302 may be formed in regions corresponding to the LRF 34 and the IR camera 35. An optical filter may be optionally provided in the light-transmissive window 301 or in each of the auxiliary light-transmissive windows 302 depending on the purpose of use of the three-axis gimbal 1.

As mentioned above, the second housing 30 accommodates the camera module 33 and the second bracket 32, in which the pitch rotary shafts 23 and the roll rotary shaft 36 are provided. Pitch rotation is made with respect to the entire second housing 30, whereas roll rotation is made with respect only to the camera module 33 while the second housing 30 is being fixed. Because there is no additional housing provided for the roll rotary shaft 36 other than the first and second housings 10 and 30, a roll motor (not illustrated) for providing roll rotation may be driven with a small power, and any additional waterproof/dustproof element such as an oil seal may become unnecessary.

It will hereinafter be described how the second bracket 32 and the camera module 33 of the three-axis gimbal 1 are connected with reference to FIGS. 7 and 8.

FIG. 7 illustrates the second bracket 32 and the camera module 33 of the three-axis gimbal 1 according to the present exemplary embodiment, and FIG. 8 also illustrates the second bracket 32 and the camera module 33 of the three-axis gimbal 1 according to the present exemplary embodiment, as viewed from a different angle from that of FIG. 7.

The pitch rotary shafts 23 are elements rotating the second housing 30, which is included in the three-axis gimbal 1, in the pitch direction. Referring back to FIG. 5, the pitch direction refers to a direction of rotation around an axis provided on a horizontal plane (i.e., plane extending perpendicular to the gravitational direction) and extending in a direction orthogonal to the direction that the cameras of the three-axis gimbal 1 face when the three-axis gimbal 1 is installed on the UAV. The pitch rotary shafts 23 are disposed in a direction parallel to the plane where the UAV and the three-axis gimbal 1 meet when the three-axis gimbal 1 is installed and connected to the UAV. Accordingly, the pitch rotary shafts 23 may rotate in the pitch direction.

The pitch rotary shafts 23 may be rotatably connected to the pitch-direction driving devices 21, which are formed at the first extensions 221. In response to the pitch-direction driving devices 21 being driven, the pitch rotary shafts 23 may rotate, and as a result, the second housing 30 may rotate relative to the UAV in the pitch direction.

Pitch motors (not illustrated) are elements included in the pitch-direction driving device 21. Because the pitch-direction driving devices 21 are coupled to the first extensions 221, the pitch motors are also coupled to the first extensions 221. DC motors may preferably be used as the pitch motors, in which case, the second housing 30 can be moved in the pitch direction by a desired amount with a small power without a requirement of an additional element such as an encoder. However, the type of motors that may be used as the pitch motors is not particularly limited.

The pitch-directional driving devices 21 are elements moving and rotating the second housing 30 in the pitch direction and may include not only the pitch motors, but also elements such as bearings, to stably rotate the second housing 30 in the pitch direction.

In the present exemplary embodiment, two first extensions 221 may be formed on the first bridge 222. Thus, a total of two pitch-direction driving devices 21 may be formed at the two first extensions 221, respectively, and a total of two pitch motors may also be formed at the two first extensions 221, respectively. One pitch rotary shaft 23 may be provided, and both ends of the pitch rotary shaft 23 may be rotatably connected to the first extensions 221, respectively. However, in the present exemplary embodiment, two independent pitch rotary shafts 23 are provided and are connected to the first extensions 221, respectively. Accordingly, elements may be further provided in a region between the first extensions 221.

First ends of the pitch rotary shafts 23 are rotatably supported by the first extensions 221, and second ends of the pitch rotary shafts 23 are connected to the second bracket 32, which is disposed between the first extensions 221. That is, the second bracket 32 may be mounted on the pitch rotary shafts 23, and the second bracket 32 may rotate in the pitch direction in accordance with the rotation of the pitch rotary shafts 23 in the pitch direction.

The second bracket 32 is an element connecting the first bracket 22 and the camera module 33 and may be configured to include the second bridge 322 and second extensions 321, which are connected to the second bridge 322.

The second extensions 321 are elements providing locations for the pitch rotary shafts 23 to be coupled to such that the second housing 30 may rotate in the pitch direction. The second extensions 321 may extend from both ends of the second bridge 322, and the pitch rotary shafts 23, which are rotatably supported by the first extensions 221, are connected to regions near second ends of the second extensions 321. Two or more second extensions 321 may be provided, but the number of second extensions 321 is not particularly limited. In the present exemplary embodiment, a total of two second extensions 321 are provided, one at each end of the second bridge 322 along an extending direction of the second bridge 322.

Because first ends of the second extensions 321 are connected to the second bridge 322 and the pitch rotary shafts 23 are supported in the regions near the second ends of the second extensions 321, the first extensions 221 and the second extensions 321 may be connected indirectly through the pitch rotary shafts 23. In the present exemplary embodiment, because the first ends of the pitch rotary shafts 23 are rotatably supported by the first extensions 221, the second bracket 32, which is supported by the second ends of the pitch rotary shafts 23, may rotate in the pitch direction in accordance with the rotation of the first ends of the pitch rotary shafts 23.

In a case in which two or more second extensions 321 are provided, the second bridge 322 of the second bracket 32 may connect the two or more second extensions 321, and the first ends of the second extensions 321 are coupled to both ends of the second bridge 322.

The second bridge 322 not only connects the second extensions 321, but also rotatably supports the roll rotary shaft 36. The roll rotary shaft 36 is supported by a part of the second bridge 322 to which the second extensions 321 are not coupled, and a roll-direction driving device 31 is coupled to the roll rotary shaft 36 so as for the roll rotary shaft 36 to be rotatable in the roll direction.

In the present exemplary embodiment, the second bracket 32 includes the second bridge 322 and two second extensions 321 thereby forming a U-shape. However, the shape of the second bracket 32 is not particularly limited to the U shape illustrated in FIGS. 7 and 8.

The roll rotary shaft 36 is an element rotating the three-axis gimbal 1 in the roll direction. The roll direction refers to a direction of rotation around an axis extending in the direction that the camera unit 33 of the three-axis gimbal 1 faces when the three-axis gimbal 1 is installed on the UAV referring to FIG. 5. The roll rotary shaft 36 extends from the second bridge 322 of the second bracket 32 and rotates in the roll direction.

The roll rotary shaft 36 may be rotatably connected to the roll-direction driving device 31, which is formed on the second bridge 322. In response to the roll-direction driving device 31 being driven, the roll rotary shaft 36 may rotate, and as a result, the camera module 33 may rotate relative to the UAV in the roll direction as shown in FIG. 5.

The three-axis gimbal 1, which is used in the UAV, is required to freely rotate in the yaw and pitch directions not only to maintain balance in captured images, but also to capture images from various angles. However, large-scale roll-direction correction is not much needed, except when there is a sudden change of speed or direction of the UAV. Thus, the rotation range of the roll rotary shaft 36 may be limited to a range from −30° to +30° such that the roll rotary shaft 36 may rotate up to 30° in both clockwise and counterclockwise directions from its initial installation state.

The roll motor is an element included in the roll-direction driving device 31. Because the roll-direction driving device 31 is coupled to the second bridge 322, the roll motor is also coupled to the second bridge 322. A DC motor may preferably be used as the roll motor, in which case, the camera module 33 can be moved in the roll direction by a desired amount with a small power without a requirement of an additional element such as an encoder. However, the type of motor that may be used as the roll motor is not particularly limited.

The roll-directional driving device 31 is an element moving and rotating the camera module 33 in the roll direction and may include not only the roll motor, but also elements such as bearings, to stably rotate the camera module 33 in the roll direction.

A first end of the roll rotary shaft 36 is supported by the second bridge 322 so as for the roll rotary shaft 36 to be rotatable in the roll direction, and a second end of the roll rotary shaft 36 is coupled to the camera module 33 to support the camera module 33. Thus, in response to the roll rotary shaft 36 being rotated by the roll-direction driving device 31, the camera module 33 may rotate in the roll direction. Because the roll rotary shaft 36 is formed in the second bracket 32, the camera module 33, which is connected to the second bracket 32, may rotate in the pitch direction in accordance with the rotation of the second bracket 32 about the pitch rotary shafts 23 along the pitch direction.

It will hereinafter be described how a second bracket 32 and a camera module 33 of a three-axis gimbal 1 according to a second exemplary embodiment of the present disclosure are connected with reference to FIG. 9.

FIG. 9 illustrates the second bracket 42 and the camera module 33 of the three-axis gimbal 1 according to another exemplary embodiment.

Specifically, the second bracket 32 of the three-axis gimbal 1 according to the exemplary embodiment of FIGS. 7 and 8 is U-shaped. However, when the camera module 33 and the other cameras are all connected to the roll rotary shaft 36, which is rotatably supported by the second bridge 322 of the second bracket 32, a cantilever beam-like structure is formed to be connected to the camera module 33, and as a result, the unfixed end of the camera module 33 may sag down due to the added load of the camera module 33.

To address this problem, the second bracket 42 of FIG. 9 may have a quadrangular shape, rather than a U shape shown in FIGS. 7 and 8. Referring to FIG. 9, the second bracket 42 includes not only a second bridge 422, but also a third bridge 423, which is provided opposite to the second bridge 422, and the second and third bridges 422 and 423 connect second extensions 421. First ends of the second extensions 421 are connected to the second bridge 422, and second ends opposite to the first ends of the second extensions 421 are connected to the third bridge 423. Pitch rotary shafts 23 are connected to middle parts of the second extensions 421 so as for the second bracket 42 to be rotatable in the pitch direction.

The second bridge 422, like its counterpart of the exemplary embodiment shown in FIGS. 7 and 8, rotatably supports a roll rotary shaft 36. The third bridge 423 is located on the opposite side of the second bridge 422 with respect to pitch rotary shafts 23, and is positioned in a direction that an image pickup unit 331 of a camera module 33 faces. Because the third bridge 423 should not interfere with the receiving of light, from a subject, by the image pickup unit 331, a portion of the third bridge 423 corresponding to the image pickup unit 331 may be formed as an open or transparent portion 424.

Also, in order to prevent the camera module 33 from sagging down, a side of the camera module 33 opposite to the side of the camera module 33 coupled to the roll rotary shaft 36 may be coupled to the third bridge 423. Thus, opposite ends of the camera module 33 along the extending direction of the second extensions 421 are supported by the second bridge 422 and the third bridge 423.

However, because the second bracket 42 should support the camera module 33 not to cause the camera module 33 to sag down, while not interfering with the rotation of the camera module 33 in the roll direction, the third bridge 423 and the camera module 33 may be coupled through a rotating member 425, which secures the rotation of the camera module 33 in the roll direction. Because the rotating member 425 should not interfere with the capturing of an image, a portion of the rotating member 425 corresponding to the image pickup unit 331 may be formed as an open or transparent portion. Thus, a ring-shaped rotating member 425 may preferably be provided.

A three-axis gimbal 2 according to an exemplary embodiment of the present disclosure, which differs from the three-axis gimbals according to the above-described exemplary embodiments in the arrangement direction of a camera module 53, will hereinafter be described with reference to FIG. 10.

FIG. 10 is a perspective view illustrating an interior structure of the three-axis gimbal 2 according to an exemplary embodiment.

In a case in which a gimbal is used in a UAV, a camera module of the gimbal originally faces a direction parallel to a roll rotary shaft as a default position, as mentioned above with regard to the exemplary embodiment shown in FIG. 5. When flying at high altitude, the UAV may capture images in a vertically downward direction. In this case, if the camera module of the gimbal originally faces the direction parallel to the roll rotary shaft (i.e., extends parallel with plane orthogonal to the direction of gravity), the roll rotary shaft and a yaw rotary shaft may coincide with each other when the camera module of the gimbal is directed to the vertically downward direction by rotating pitch rotary shafts, and thus, a problem may arise in which only two axes are controllable. This problem is referred to as a gimbal lock phenomenon.

To prevent the gimbal lock phenomenon, the camera module of the gimbal may preferably be configured to initially face the vertically downward direction, especially when the gimbal is used in a UAV that captures images mainly in the vertically downward direction. For example, referring to FIG. 10, an image pickup section 331 of the camera module 53, which is connected to a second bracket 32, is oriented to a vertically downward direction that is orthogonal to a roll rotary shaft 36 and pitch rotary shafts 23, rather than a direction parallel to the roll rotary shaft 36. In this manner, the gimbal lock phenomenon may be prevented, and the three-degrees-of-freedom rotation of the three-axis gimbal 2 may be secured.

Cameras 54 and 55 may preferably be oriented to the same direction as the camera module 53. In the third exemplary embodiment, like in the first exemplary embodiment, the cameras 54 and 55 may be coupled to a side of the camera module 53.

It will be understood by those skilled in the art that the inventive concept may be embodied in other specific forms without departing from the technical idea or essential characteristics thereof. It is therefore to be understood that the exemplary embodiments described above are illustrative in all aspects and not restrictive. The scope of the inventive concept is defined by the appended claims rather than the detailed description and all changes or modifications derived from the meaning and scope of the claims and their equivalents are to be construed as being included within the scope of the present invention do.

In concluding the detailed description, those skilled in the art will appreciate that many variations and modifications can be made to the exemplary embodiments without substantially departing from the spirit and scope of the inventive concept as defined by the following claims.

1. A three-axis gimbal, comprising:
a first housing comprising a first rotary shaft, the first rotary shaft configured to rotate the first housing in a first direction;
a first bracket attached to, and extending from the first housing;
a second bracket comprising at least one second rotary shaft, the at least one second rotary shaft rotatably supported by the first bracket, the second bracket configured to be rotatable in a second direction;
a camera module comprising a third rotary shaft, the third rotary shaft rotatably supported on the second bracket, the camera module configured to be rotatable in a third direction; and
a second housing accommodating the at least one second rotary shaft and the third rotary shaft,
wherein the camera module includes an image capturer configured to capture an image of surroundings of the camera module, and
wherein the image capturer is disposed to face a direction that is orthogonal to the third rotary shaft and the at least one second rotary shaft.

2. The three-axis gimbal of claim 1, wherein the at least one second rotary shaft extend in a direction substantially orthogonal to the first rotary shaft and the third rotary shaft, and
wherein the first rotary shaft extends in a direction substantially orthogonal to the third rotary shaft.

3. The three-axis gimbal of claim 2, wherein the first housing and the first bracket are configured to rotate about the first rotary shaft, the second bracket is configured to rotate about the first rotary shaft and the at least one second rotary shaft, and the camera module is configured to rotate about the first rotary shaft, the at least one second rotary shaft and the third rotary shaft.

4. The three-axis gimbal of claim 1, wherein the second bracket is configured to rotate with respect to the first bracket, and the camera module is configured to rotate with respect to the second bracket.

5. The three-axis gimbal of claim 1, further comprising:
a dome cover accommodating the first housing and the first bracket.

6. The three-axis gimbal of claim 1, wherein the first bracket comprises:
a first bridge attached to the first housing; and
a plurality of first extensions extending from opposite ends of the first bridge to rotatably support the at least one second rotary shaft.

7. The three-axis gimbal of claim 1, wherein the second bracket comprises:
a second bridge supporting the third rotary shaft; and
a plurality second extensions extending from opposite ends of the second bridge, each of the at least one second rotary shaft protruding from a respective second extension.

8. The three-axis gimbal of claim 1, wherein the second bracket comprises:
two second extensions comprising a left second extension and a right second extension, the left and right second extensions rotatably supported by the at least one second rotary shaft;
a second bridge connecting first ends of the two second extensions and supports the third rotary shaft; and
a third bridge connecting second ends of the two second extensions and rotatably supports a first end of the camera module so as for the camera module to be rotatable about a direction of the third rotary shaft.

9. The three-axis gimbal of claim 5, wherein a portion of the third bridge that supports the camera module is configured to transmit light therethrough.

10. The three-axis gimbal of claim 1, wherein the first housing is configured to accommodate a controller configured to control the three-axis gimbal.

11. The three-axis gimbal of claim 1, wherein the second housing is formed as a radial torus and is configured to rotate about the secondary rotary shaft.

12. The three-axis gimbal of claim 1, wherein a rotation angle of the third rotary shaft is in a range of −30° to +30°.

13. The three-axis gimbal of claim 1, further comprising:
a first motor configured to drive the first rotary shaft;
a second motor configured to drive one of the at least one second rotary shaft; and
a third motor configured to drive the third rotary shaft.

14. The three-axis gimbal of claim 1, wherein:
the camera module includes an image capturer configured to capture an image of surroundings of the camera module, and
the image capturer is disposed along the third rotary shaft.

15. (canceled)

16. The three-axis gimbal of claim 1, wherein the first bracket includes two first extensions attached to the first housing and extending from the first housing to rotatably support the at least one second rotary shaft.

17. A three-axis gimbal, comprising:
a first housing comprising:
a first rotary shaft, the first rotary shaft configured to drive the first housing in a first rotational direction; and
a first bracket attached to, and extending from the first housing; and
a second housing comprising
a second bracket rotatably attached to the first bracket via a left second rotary shaft and a right second rotary shaft, the second bracket configured to rotate with respect to the first bracket; and
a camera module comprising a third rotary shaft, the third rotary shaft rotatably supported on the second bracket, the camera module configured to be rotatable with respect to the second bracket,
wherein the camera module is configured to rotate with respect to the first bracket and the first housing,
wherein the left and right second rotary shafts extend in a direction substantially orthogonal to the first rotary shaft and the third rotary shaft, and
wherein the first rotary shaft extends in a direction substantially orthogonal to the third rotary shaft.

18. (canceled)

19. The three-axis gimbal of claim 17, wherein the first bracket comprises:
a first bridge attached to the first housing; and
a left first extension and a right first extension extending from opposite ends of the first bridge, and
wherein the left first extension supports the left second rotary shaft, and the right first extension supports the right second rotary shaft.

20. The three-axis gimbal of claim 19, wherein the second housing is provided between the left first extension and the right first extension.
